(19) United States
(12) Patent Application Publication
(10) Pub. No.: US 2024/0140482 A1
(43) Pub. Date: May 2, 2024

(54) IDENTIFYING EVENTS BASED ON CHANGES IN ACTOR IMPORTANCE

(71) Applicant: GM Cruise Holdings LLC, San Francisco, CA (US)

(72) Inventors: Chingiz Tairbekov, San Francisco, CA (US); Logan Perreault, Billings, MT (US); Kahye Song, Menlo Park, CA (US); Rizwan Chaudhry, Millbrae, CA (US)

(21) Appl. No.: 17/976,238

(22) Filed: Oct. 28, 2022

(51) Int. Cl. B60W 60/00; B60W 40/04

(52) U.S. Cl. CPC B60W 60/0011; B60W 40/04; B60W 2554/4041; B60W 2556/05

(57) ABSTRACT

Aspects of the subject technology relate to systems, methods, and computer-readable media for selecting a portion of raw data to process based on an importance of an agent in the portion of the raw data. Raw autonomous vehicle (AV) data associated with the AV operating in an environment can be accessed. An agent in the environment can be classified as a significant agent based on a potential for the agent to interact with the AV in the environment. A subset of the raw AV data associated with a classification of the agent as the significant agent can be selected. processing of the subset of the raw AV data separate from the raw AV data excluded from the subset of the raw AV data can be facilitated.

### BACKGROUND

### 1. Technical Field

The present disclosure generally relates to selecting a portion of raw data to process and, more specifically, to selecting a portion of raw data to process based on an importance of an agent in the portion of the raw data.

### 2. Introduction

An autonomous vehicle (AV) is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying the drawings in which:

FIG. 1 illustrates an example system environment that can be used to facilitate AV dispatch and operations, according to some examples of the present disclosure;

FIG. 2 illustrates a conceptual flow of an example software stack that is run in association with the operation of an AV, according to some examples of the present disclosure;

FIG. 3 illustrates a flowchart for an example method of selecting and processing a subset of raw AV data based on agent significance, according to some examples of the present disclosure;

FIG. 4, illustrates a diagram of a changing position of an agent in a ranking of significance, according to some examples of the present disclosure;

FIG. 5, illustrates a diagram of a changing ranking of significance of a plurality of agents based on the introduction of another agent in the ranking, according to some examples of the present disclosure; and

FIG. 6 illustrates an example processor-based system with which some aspects of the subject technology can be implemented, according to some examples of the present disclosure.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

A software stack can be used to control an autonomous vehicle. In particular, a software stack can include various dependent processes that can be implemented to control an autonomous vehicle. In order to both develop the software stack and control an autonomous vehicle, a large amount of data is needed. Data for developing the software stack can be collected by the AV during operation. Specifically, the AV can record sensory information captured by sensors and outputs from various AV nodes, e.g. software stack nodes, that are run during operation of the nodes. Such data can be referred to as raw AV data. This data can be used to analyze the behavior of the AV and to mine for on-road scenes of interest.

The large amounts of data that are collected during operation of the AVs on the road can make it difficult to determine what specific road scenes, and corresponding subsets of the gathered data, actually have valuable information, e.g. for purposes of developing the software stack. For example, scenes that resulted in a significant change in a planning decision, e.g. sudden changes in AV trajectory such as hard braking, swerving, accelerating, can correspond to a scene of interest. However, it can be difficult to identify these scenes without expending great amounts of computation resources.

Scenes of interest can be identified by partially processing the gathered raw data through the software stack. Specifically, the software stack can be run all the way through a planning stack and diagnostic information for identifying scenes of interest can be determined from the output of the planning stack. However, running the software stack through to the planning stack for the large amounts of captured raw data consumes a large amount of resources. Further, a large amount of diagnostic data is generated as output of the planning stack, e.g. in relation to the sensor data captured by the AV, and this data has to be analyzed in order to identify scenes of interest. As a result, it is difficult to identify scenes of interest through output of the planning stack on the road while the AV captures data. Further, it is prohibitively expensive to process the captured road data through to the planning stack offline and identify scenes of interest after the AV has captured the data on the road.

The disclosed technology addresses the problems associated with identifying scenes of in captured AV data, e.g. raw AV data, by identifying scenes of interest in portions of raw AV data based on importance of an agent in the raw AV data. While the present technology is described with respect to AVs, the technology can be applied to an applicable scenario where a large amount of data is captured and needs to be processed to identify subsets of the data that correspond to portions of interest.

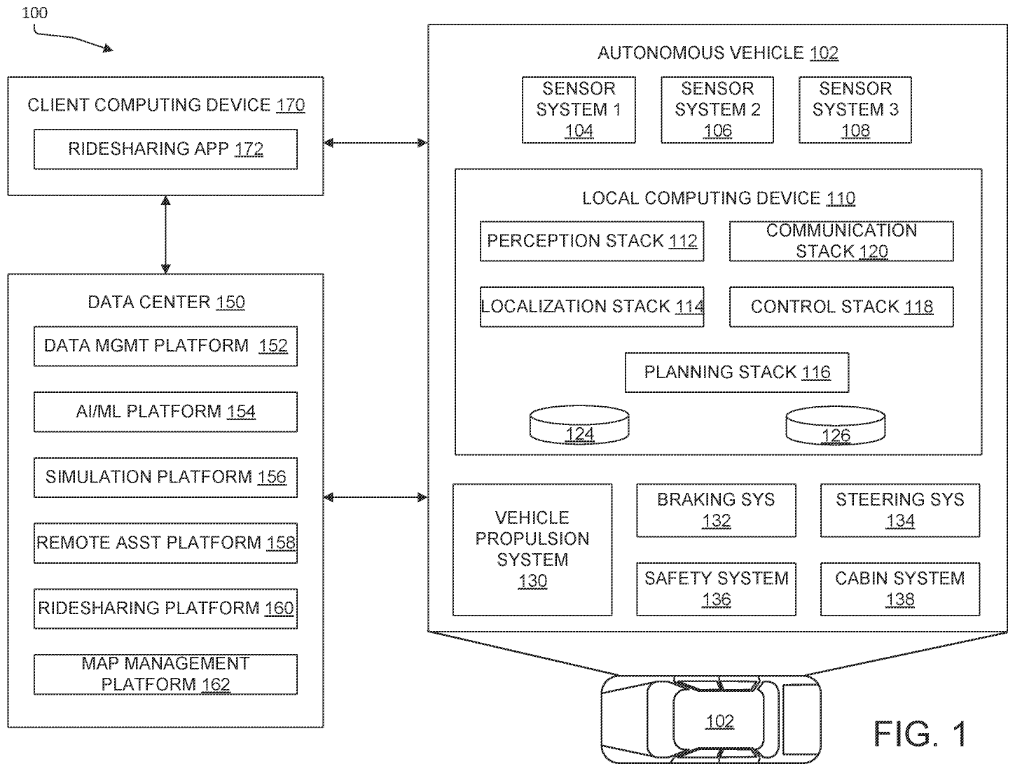

FIG. 1 illustrates an example of an AV management system 100. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 102 can navigate about roadways without a human driver based on sensor signals generated by multiple sensor systems 104, 106, and 108. The sensor systems 104-108 can include different types of sensors and can be arranged about the AV 102. For instance, the sensor systems 104-108 can comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., Global Positioning System (GPS) receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other embodiments may include any other number and type of sensors.

AV 102 can also include several mechanical systems that can be used to maneuver or operate AV 102. For instance, the mechanical systems can include vehicle propulsion system 130, braking system 132, steering system 134, safety system 136, and cabin system 138, among other systems. Vehicle propulsion system 130 can include an electric motor, an internal combustion engine, or both. The braking system 132 can include an engine brake, a wheel braking system (e.g., a disc braking system that utilizes brake pads), hydraulics, actuators, and/or any other suitable componentry configured to assist in decelerating AV 102. The steering system 134 can include suitable componentry configured to control the direction of movement of the AV 102 during navigation. Safety system 136 can include lights and signal indicators, a parking brake, airbags, and so forth. The cabin system 138 can include cabin temperature control systems, in-cabin entertainment systems, and so forth. In some embodiments, the AV 102 may not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

AV 102 can additionally include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a planning stack 116, a control stack 118, a communications stack 120, an High Definition (HD) geospatial database 122, and an AV operational database 124, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 122, other components of the AV, and other data sources (e.g., the data center 150, the client computing device 170, third-party data sources, etc.). The perception stack 112 can detect and classify objects and determine their current and predicted locations, speeds, directions, and the like. In addition, the perception stack 112 can determine the free space around the AV 102 (e.g., to maintain a safe distance from other objects, change lanes, park the AV, etc.). The perception stack 112 can also identify environmental uncertainties, such as where to look for moving objects, flag areas that may be obscured or blocked from view, and so forth.

Mapping and localization stack 114 can determine the AV's position and orientation (pose) using different methods from multiple systems (e.g., GPS, IMUs, cameras, LIDAR, RADAR, ultrasonic sensors, the HD geospatial database 122, etc.). For example, in some embodiments, the AV 102 can compare sensor data captured in real-time by the sensor systems 104-108 to data in the HD geospatial database 122 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The planning stack 116 can determine how to maneuver or operate the AV 102 safely and efficiently in its environment. For example, the planning stack 116 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 102 from one point to another. The planning stack 116 can determine multiple sets of one or more mechanical operations that the AV 102 can perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 116 can select from multiple backup plans to carry out. For example, while preparing to change lanes to turn right at an intersection, another vehicle may aggressively cut into the destination lane, making the lane change unsafe. The planning stack 116 could have already determined an alternative plan for such an event, and upon its occurrence, help to direct the AV 102 to go around the block instead of blocking a current lane while waiting for an opening to change lanes.

The control stack 118 can manage the operation of the vehicle propulsion system 130, the braking system 132, the steering system 134, the safety system 136, and the cabin system 138. The control stack 118 can receive sensor signals from the sensor systems 104-108 as well as communicate with other stacks or components of the local computing device 110 or a remote system (e.g., the data center 150) to effectuate operation of the AV 102. For example, the control stack 118 can implement the final path or actions from the multiple paths or actions provided by the planning stack 116. This can involve turning the routes and decisions from the planning stack 116 into commands for the actuators that control the AV's steering, throttle, brake, and drive unit.

The communication stack 120 can transmit and receive signals between the various stacks and other components of the AV 102 and between the AV 102, the data center 150, the client computing device 170, and other remote systems. The communication stack 120 can enable the local computing device 110 to exchange information remotely over a network, such as through an antenna array or interface that can provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 120 can also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 122 can store HD maps and related data of the streets upon which the AV 102 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane or road centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer can include geospatial information of traffic signal lights, traffic signs, and other road objects and related attributes.

The AV operational database 124 can store raw AV data generated by the sensor systems 104-108 and other components of the AV 102 and/or data received by the AV 102 from remote systems (e.g., the data center 150, the client computing device 170, etc.). In some embodiments, the raw AV data can include HD LIDAR point cloud data, image or video data, RADAR data, GPS data, and other sensor data that the data center 150 can use for creating or updating AV geospatial data.

The data center 150 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes one or more of a data management platform 152, an Artificial Intelligence/Machine Learning (AI/ML) platform 154, a simulation platform 156, a remote assistance platform 158, a ridesharing platform 160, and a map management platform 162, among other systems.

Data management platform 152 can be a “big data” system capable of receiving and transmitting data at high speeds (e.g., near real-time or real-time), processing a large variety of data, and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102 and from third party sources, including rendering geospatial information and road infrastructure (e.g., streets, lanes, crosswalks, traffic lights, stop signs, etc.) obtained from the map management platform 162; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general purpose computing device for accessing the ridesharing application 172. The client computing device 170 can be a customer's mobile computing device or a computing device integrated with the AV 102 (e.g., the local computing device 110). The ridesharing platform 160 can receive requests to be picked up or dropped off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit en route to a pick-up or drop-off location, and so on.

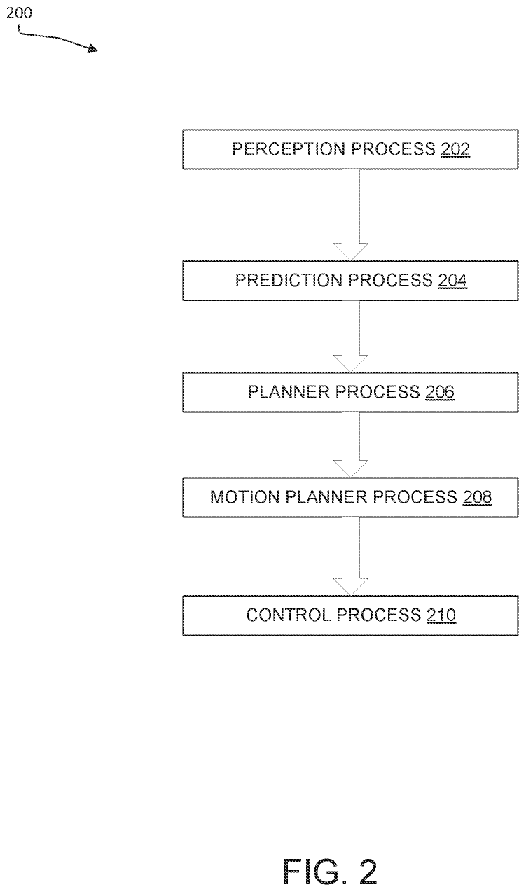

FIG. 2 illustrates a conceptual flow 200 of an example software stack that is run in association with the operation of an AV. The example AV software stack shown in FIG. 2 includes applicable processes that can be used in controlling an AV, such as the stacks shown in FIG. 1. Specifically, the example AV software stack shown in FIG. 2 includes a perception process 202, a prediction process 204, a planner process 206, a motion planner process 208, and a control process 210.

The perception process 202 functions to access sensor data gathered by an AV. The perception process 202 can fuse the sensor data. From the sensor data, the perception process 202 can track objects. Specifically, the perception process 202 can identify where tracked objects are in a field of view, e.g. relative to the AV.

The prediction process 204 functions to predict where objects will be in a field of view. Specifically, the prediction process 204 can predict the location of objects that are not tracked by the perception process 202. The prediction process 204 can predict the location of objects based on the tracked object output of the perception process 202.

The planner process 206 functions to identify a path for the AV. Specifically, the planner process 206 functions to identify a path for the AV based on either or both the output of the perception process 202 and the prediction process 204. In identifying a path for the AV, the planner process can weigh various moves by the AV against costs with respect to the output of either or both the perception process 202 and the prediction process 204.

The motion planner process 208 functions to identify a refined path for the AV. In particular, the motion planner process 208 functions to identify a refined path for the AV with respect to the path identified by the planner process 206. A refined path developed by the motion planner process 208 can include a path that is planned according to smaller time operations and smaller distances in comparison to the scheme that is used to develop the path by the planner process 206.

The control process 210 functions to communicate with control systems of the AV to implement the plan developed by either or both the planner process 206 and the motion planner process 208. Specifically, the control process 210 can communicate values of parameters for controlling the AV to applicable systems for controlling the AV. For example, the control process 210 can specify to an acceleration controller of the AV to accelerate at 10%.

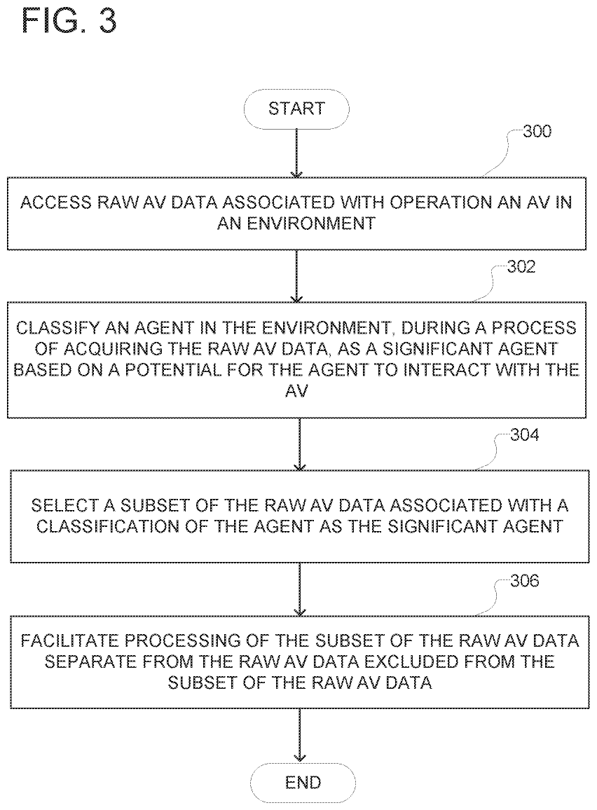

The disclosure now continues with a discussion of selecting scenes of interest in raw AV data based on identified significant agents represented in the raw AV data. Specifically, FIG. 3 illustrates a flowchart for an example method of selecting and processing a subset of raw AV data based on agent significance. The method shown in FIG. 3 is provided by way of example, as there are a variety of ways to carry out the method. Additionally, while the example method is illustrated with a particular order of operations, those of ordinary skill in the art will appreciate that FIG. 3 and the modules shown therein can be executed in any order and can include fewer or more modules than illustrated. Each module shown in FIG. 3 represents one or more operations, processes, methods or routines in the method.

At operation 300, raw AV data associated with operation of an AV in an environment is accessed. Raw AV data can include applicable data that is gathered by an AV as the AV operates in an environment, e.g. a real-world environment. Specifically, raw AV data can include sensor data that is gathered by sensors as the AV performs various maneuvers in a real-world environment. For example, raw AV data can include data captured by a LIDAR sensor that is indicative of agents surrounding an AV in an environment. An agent, as used herein, can include an object in an environment in which an AV is operating. Specifically, an agent can include an object in an environment that affects operation of an AV in the environment. For example, an agent can include a pedestrian in a crosswalk. In another example, an agent can include another vehicle driving next to an AV.

Raw AV data can also include data that is generated in running a software stack associated with operation of an AV. Specifically, raw AV data can include data that is generated by running all or a portion of the software stacks shown in FIG. 2. For example, raw AV data can include an output of running a perception stack. In turn, the output of the perception stack can include an indication of agents in an environment. Specifically, the output of the perception stack can include trajectories of agents in the environment as the agents move, e.g. relative to an AV. For example, raw AV data can include a trajectory of a car driving next to an AV in a real-world environment.

Agents can enter and leave an environment, as reflected by accessed raw AV data. In turn, the number of agents in a scene, corresponding to a portion of time in which an AV is operating in an environment, can change over time. For example, a pedestrian in a crosswalk can enter a scene as an AV approaches the crosswalk. As follows, the pedestrian can leave the scene as the AV drives away from the crosswalk. In another example, a car can enter a scene as the car moves next to the AV. As follows, the car can leave the scene as the car turns down a different road from the one being traversed by the AV.

Raw AV data can be indicative of positions and trajectories of agents in an environment. The positions and trajectories of agents, as indicated by the raw AV data, can include past positions and trajectories of the agents in an environment. For example, raw AV data can include sensor information indicating a path that has been traversed by a pedestrian. The positions and trajectories of agents, as indicated by the raw AV data, can also include predicted positions and trajectories of the agents in an environment. For example, an output of a prediction stack that is included as part of the raw AV data, can include a predicted trajectory of a car in an environment.

At operation 302, an agent in the environment is classified as a significant agent. Significance with respect to an agent, as used herein, can be quantified with respect to the AV. Specifically, significance of an agent can be quantified based on a potential for the agent to interact with the AV in the environment. More specifically, the significance of the agent can be quantified based on an effect of the agent on the operation of the AV in the environment. For example, an object that is approaching the AV and causes the AV to change its path can be quantified as significant. Further in the example, a pedestrian that is a block away from the AV can be quantified as insignificant.

Significance of an agent can be quantified through one or more applicable metrics. For example, a significance of an agent can be expressed as a numerical value on a scale representative of different significance levels. Different agents can have different significance levels in an environment. As follows, the agents can be ranked in the environment based on their significances. For example, a pedestrian in a path of the AV can be ranked high, corresponding to a high level of significance, while an automobile that is traveling in an opposite direction from the AV can be ranked low, corresponding to a low level of significance.

A trajectory of either or both an agent and the AV can be used to identify a significance of an agent. Specifically, a trajectory of an agent can be predicted through an applicable software stack, e.g. the prediction process. In turn, the trajectory of the agent can be analyzed to estimate an impact of the object on a trajectory of the AV, e.g. from a planning cost perspective. As follows, the trajectory of the agent can be tracked over time and compared with the changing trajectory of the AV to determine the effect of the agent on the AV and a corresponding significance of the agent. For example, if a large amount of planning resources are expended in analyzing and changing a route of the AV to avoid an object, then an importance of the object can be classified as significant. Conversely, if a small amount of no planning resources have to be expended in planning and changing a route of the AV because of a pedestrian, then a significance of the pedestrian can be classified as low.

In using trajectories to identify a significance of an agent, sudden changes in trajectories of either or both the agent and the AV can be used in identifying the significance of the agent. Specifically, the trajectories of both the AV and the agent can be monitored over time, e.g. at least two consecutive ticks, to determine a sudden change in the trajectory of the AV and potentially the agent. This can be used to determine that the agent caused the AV to change trajectory instead of another factor in the environment. For example, a pedestrian that suddenly changes direction into a crosswalk in from the AV can generate high planning costs associated with the AV trajectory that change. This is in contrast to a scenario where an AV stops because of a changing light and not because of another agent. Specifically, the changing trajectory of the pedestrian is confirmed as causing the changing trajectory of the AV. In turn, the pedestrian can be identified as a significant agent.

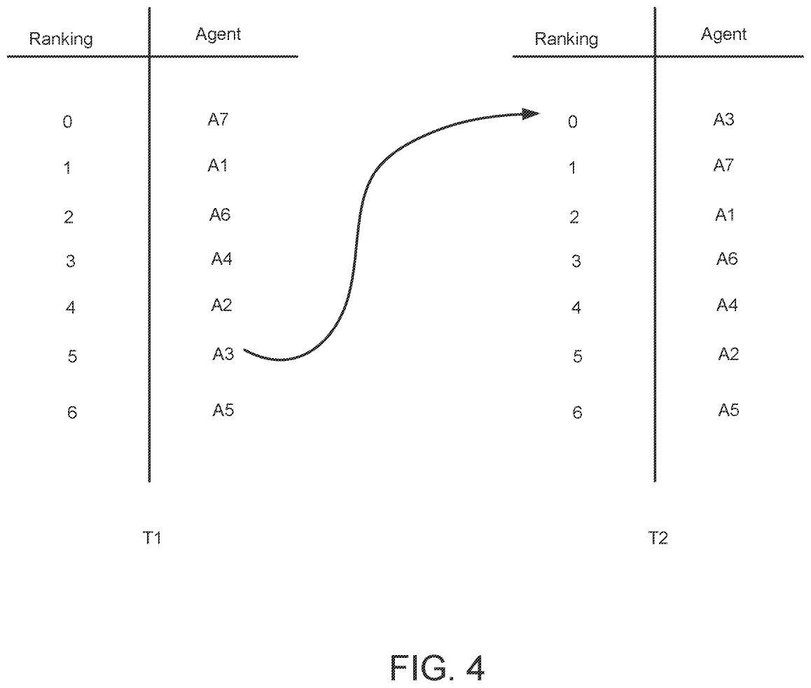

Significance of an agent can be identified and used to rank an agent amongst a plurality of agents. In turn, agents can be labeled as significant according to significance rankings amongst a plurality of agents through an applicable technique. Specifically, an agent can be classified as a significant agent based on a changing position of the agent in a significance ranking of a plurality of agents. FIG. 4, is an illustration of a changing position of an agent in a ranking of significance. FIG. 4 includes a first ranking of a plurality of agents in an environment at time T1. In the first ranking, the agents are ranked in a descending order of significance. Specifically, A7 is ranked as the most significant, followed by A1, followed by A6, followed by A4, followed by A2, followed by A3, and A5 is ranked last. Agents can be labeled as significant agents based on this ranking. Specifically, the agents can be labeled as significant based on the corresponding quantified significances of the agents in relation to a threshold. For example, A7 and A1 can be labeled as significant agents if corresponding quantifications of their significance is greater than a threshold level of significance.

FIG. 4 also includes a second ranking of the plurality of agents in the environment at time T2. T2 is a later time than T1. In the second ranking, the agents are also ranked in a descending order of significance. Specifically, in the second ranking, A3 is ranked as the most significant, followed by A7, followed by A1, followed by A6, followed by A4, followed by A2, and A5 is ranked last. When comparing the first and second rankings, A3 made a jump in the significance rankings from second to last to first in significance. This dramatic change in significance can indicate that A3 is an important agent and should be classified as a significant agent. A change in significance corresponding to an important agent can include a dramatic increase in significance is indicative of an important agent. Agents can be labeled as significant agents based on a change in a corresponding significance of the agents in relation to a threshold. For example, a threshold can specify that if an agent's significance ranking increases by three positions or more, then the agent should be classified as a significant agent. In turn, agents, irrespective of their starting position or current position in the rankings, can be labeled as significant agents if the difference between their starting position and current position is an increase in three or more positions within the ranking.

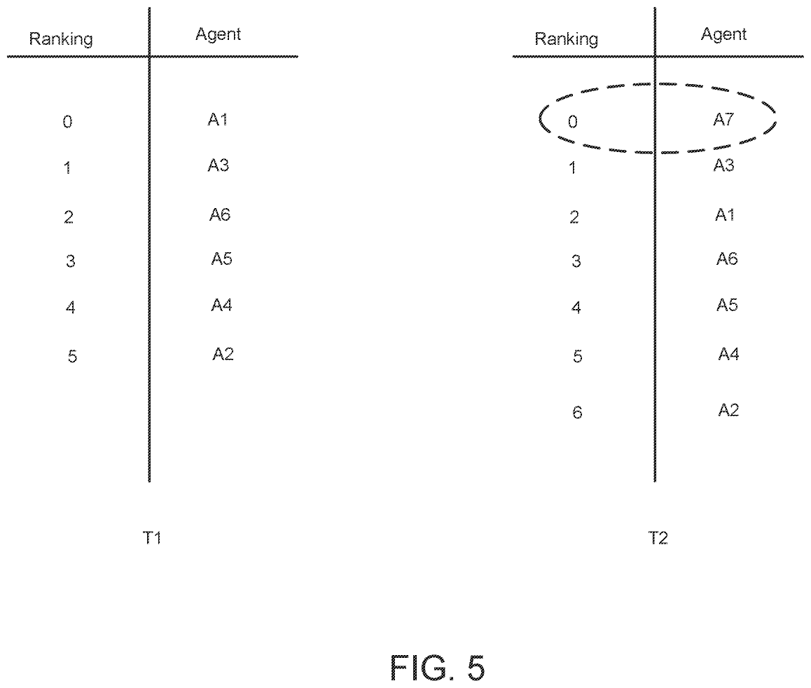

Agents can also be classified as significant based on their introductory position in a ranking of agents based on significance. FIG. 5, is an illustration of a changing ranking of significance of a plurality of agents based on the introduction of another agent in the ranking. FIG. 5 includes a first ranking at time T1. In the first ranking, the agents are ranked in a descending order of significance. Specifically, in the first ranking, A1 is ranked as the most significant agent, followed by A3, followed by A6, followed by A5, followed by A4, and finally A2.

FIG. 5 also includes a second ranking at time T2. T2 is a later time than T1. In the second ranking, the agents are also ranking in a descending order of significance. Specifically, in the second ranking, A7 first appears in the ranking as the most significant agent, followed by A3, followed by A1, followed by A6, followed by A5, followed by A4, and finally A2. An agent can be classified as a significant agent based on an introductory position of the agent in a significance ranking. An introductory position, as used herein, can include a position in a ranking where an agent is introduced or otherwise enters the ranking. An introductory position can be the position of the agent at the first time that the agent is ever ranked. Further, an introductory position can be a position of an agent in a ranking when the agent is reranked, e.g. after being excluded or removed from the ranking.

In the second ranking shown in FIG. 5, the introductory position of A7 is at the top of the significance rankings. As a result, A7 can be classified as a significant agent. An agent can be classified as a significant agent based on an introductory position of the agent in a significance ranking relative to a threshold level in the significance ranking. For example, if an introductory position of an agent is in the top three positions in the significance ranking, then the agent can be classified as a significant agent.

Returning back to the flowchart shown in FIG. 3, the agent can be classified as a significant agent during or in conjunction with a process of acquiring the raw AV data. A process of acquiring the raw AV data can include while an AV is operating on the road to gather and generate the raw AV data. As follows, the techniques for classifying the agent as a significant agent, as described herein, can be applied while the AV is operating on the road. For example, the software stack can be run through the planner process 206 to generate output as part of raw AV data while the AV operates on-road. Further in the example, the output of the planner process 206 can be analyzed, e.g. as it is generated or in proximity to times when the output is generated, to classify the agent as a significant agent.

At operation 304, a subset of the raw AV data associated with a classification of the agent as the significant agent is selected. Specifically, the raw AV data that corresponds to a time right before the agent is classified as the significant agent, the raw AV data that corresponds to a time during which the agent is classified as the significant agent, the raw AV data that corresponds to a time after which the agent is classified as the significant agent, or a combination thereof, can be selected. For example, a pedestrian can change their path and be classified as a significant agent in an operational environment of the AV. As follows, the raw AV data corresponding to when the pedestrian changed their path and a specific amount of time before the pedestrian changed their path can be selected.

The raw AV data associated with a classification of the agent as the significant agent can be selected in response to the classification of the agent as a significant agent. Accordingly, the raw AV data can correspond to scenes of interest that should be analyzed as opposed to most raw AV data which is generally stable and lacks informational value for analysis. For example, most raw AV data is generated as the AV operates in a stable environment along a stable trajectory. However, when an agent does something that causes the AV to change how it is operating, e.g. perform an evasive maneuver, then the corresponding raw AV data should be analyzed as it can contain valuable insights into operation of the AV.

In selecting the subset of the raw AV data that is associated with the classification of the agent as a significant agent, the subset of the raw AV data can be separated from the entire portion of raw AV data. For example, the portion of the raw AV data that corresponds to when a car maneuvered into a lane of the AV can be separated from the total amount of raw AV data that is generated while the AV operates on-road. In turn, and at operation 306, processing of the subset of the raw AV data separate from the raw AV data excluded from the subset of the raw AV data is facilitated. Specifically, the selected subset of the raw AV data can be processed without processing the entirety of the raw AV data. This is advantageous as this saves resources that would otherwise be used in processing the entirety of the raw AV data. For example, the entire software stack pipeline does not need to be run in its entirety on all of the raw AV data in its entirety to identify important agents and corresponding scenes of interest.

In facilitating processing of the subset of raw AV data separate from the raw data that is not included in the subset, the subset of the raw AV data can actually be processed. For example, the subset of the raw AV data can be processed separate from the AV, e.g. in a cloud environment. Further in the example, the subset of the raw AV data can be processed separate from a process of actually capturing the raw AV data, e.g. when the AV is no longer operating to gather the raw AV data. Further, the subset of the raw AV data can be provided for processing as part of facilitating processing of the subset of the raw AV data. Additionally, an identification of the subset of the raw AV data can be provided as part of facilitating processing of the raw AV data. For example, instructions can be provided that indicate to process the raw AV data between certain time stamps corresponding to the subset of the raw AV data.

Further, in facilitating processing of the subset of raw AV data, the subset of the raw AV data can be rerun through the software stack pipeline, or a portion of the pipeline, to generate diagnostics data. Specifically, the subset of the raw AV data can be run through the planning stack separate from the AV to generate diagnostic data. This can be done without running the entirety of the raw AV data through the planning stack which is expensive from a consumed resource perspective. In turn, the diagnostics data can be used to confirm the agents that are classified as significant agents without running processing the entirety of the raw AV data to confirm the significant agents. For example, the planning stack can confirm that a specific agent does actually affect the operation of the AV. Further, and as part of processing the subset of the raw AV data, the subset of the raw data can be run through the software stack pipeline in its entirety once the significant agents are confirmed as significant through the planning stack.

Specifically, raw AV data can be captured within some interval that wraps around the instantaneous increase in a tracked significance. For example, a person starts turning and then moves towards AV. Once this move is confirmed by the tracking system, which also generates some kinematic profile, the significance/importance of that person can be increased. In turn, the raw AV data before the person started moving towards the AV and the raw AV data including when the person moved towards the AV and for a time after can be separated from the entire raw AV data. In turn, other systems can train on this data and raw AV data corresponding to other interesting events. As a result, the cost of data processing is the amount of compute to run to process a tick corresponding to the subset of the raw AV data, e.g. the time interval over which data is collected and processed, and the cost of writing specific filters.

The technology described herein can also be used in controlling selective capture to selectively generate raw AV data. Specifically, a commercial fleet of AVs can record one or more topics in relation to an AV stack. A topic can include the output produced by a node of the AV stack. The data can be stored and selectively moved to a buffer based on an agent's significance. For example, if an agent becomes significant/important, then the data in the buffer corresponding to the agent being significant can be moved from the buffer to a different, e.g. more permanent, storage location.

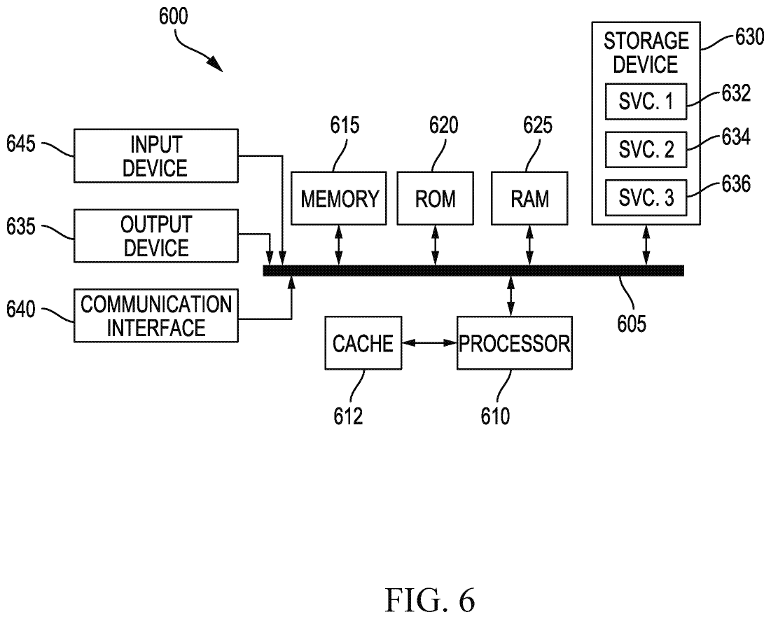

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing operations of the methods disclosed herein. The particular sequence of such executable instructions or associated data structures represents examples of corresponding acts for implementing the functions described in such operations.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A method comprising: accessing raw autonomous vehicle (AV) data associated with the AV operating in an environment; classifying an agent in the environment, during a process of acquiring the raw AV data, as a significant agent based on a potential for the agent to interact with the AV in the environment, wherein the agent is identifiable in the environment through the raw AV data; selecting a subset of the raw AV data associated with a classification of the agent as the significant agent; and facilitating processing of the subset of the raw AV data separate from the raw AV data excluded from the subset of the raw AV data.

Aspect 2. The method of Aspect 1, wherein the subset of the raw AV data includes raw AV data before the agent is classified as the significant agent, raw AV data while the agent is classified as the significant agent, raw AV data after the agent is classified as the significant agent, or a combination thereof.

Aspect 3. The method of Aspects 1 and 2, wherein the agent is classified as the significant agent from a plurality of agents in the environment that are identifiable in the environment through the raw AV data, the method further comprising: ranking the plurality of agents in the environment to generate a ranking of the plurality of agents based on a corresponding potential for each of the plurality of agents to interact with the AV in the environment; and classifying the agent as the significant agent based on a ranking of the agent amongst the plurality of agents in the ranking of the plurality of agents.

Aspect 4. The method of Aspects 1 through 3, wherein the corresponding potential for each of the plurality of agents to interact with the AV in the environment is measured based on a corresponding planning cost associated with controlling the AV in relation to each of the plurality of agents.

Aspect 5. The method of Aspects 1 through 4, further comprising classifying the agent as the significant agent based on a change in the ranking of the agent amongst the plurality of agents in the ranking of the plurality of agents.

Aspect 6. The method of Aspects 1 through 5, further comprising: comparing the change in the ranking of the agent in the ranking of the plurality of agents to a threshold ranking change; and classifying the agent as the significant agent based on a comparison of the change in the ranking of the agent to the threshold ranking change.

Aspect 7. The method of Aspects 1 through 6, further comprising classifying the agent as the significant agent based on a position of the agent in being added to the ranking of the plurality of agents.

Aspect 8. The method of Aspects 1 through 7, further comprising: comparing the position of the agent in being added to the ranking of the plurality of agents to a threshold ranking position; and classifying the agent as the significant agent based on a comparison of the position of the agent to the threshold ranking position.

Aspect 9. The method of Aspects 1 through 8, wherein the processing of the subset of the raw AV data separate from the raw AV data excluded from the subset of the raw AV data includes processing the subset of the raw AV data while refraining from processing at least a portion of the raw AV data excluded from the subset of the raw AV data.

Aspect 10. A system comprising: one or more processors; and at least one computer-readable storage medium having stored therein instructions which, when executed by the one or more processors, cause the one or more processors to: access raw autonomous vehicle (AV) data associated with the AV operating in an environment; classify an agent in the environment, during a process of acquiring the raw AV data, as a significant agent based on a potential for the agent to interact with the AV in the environment, wherein the agent is identifiable in the environment through the raw AV data; select a subset of the raw AV data associated with a classification of the agent as the significant agent; and facilitate processing of the subset of the raw AV data separate from the raw AV data excluded from the subset of the raw AV data.

Aspect 11. The system of Aspect 10, wherein the subset of the raw AV data includes raw AV data before the agent is classified as the significant agent, raw AV data while the agent is classified as the significant agent, raw AV data after the agent is classified as the significant agent, or a combination thereof.

Aspect 12. The system of Aspects 10 and 11, wherein the agent is classified as the significant agent from a plurality of agents in the environment that are identifiable in the environment through the raw AV data, and the instructions further cause the one or more processors to: rank the plurality of agents in the environment to generate a ranking of the plurality of agents based on a corresponding potential for each of the plurality of agents to interact with the AV in the environment; and classify the agent as the significant agent based on a ranking of the agent amongst the plurality of agents in the ranking of the plurality of agents.

Aspect 13. The system of Aspects 10 through 12, wherein the corresponding potential for each of the plurality of agents to interact with the AV in the environment is measured based on a corresponding planning cost associated with controlling the AV in relation to each of the plurality of agents.

Aspect 14. The system of Aspects 10 through 13, wherein the instructions further cause the one or more processors to classify the agent as the significant agent based on a change in the ranking of the agent amongst the plurality of agents in the ranking of the plurality of agents.

Aspect 15. The system of Aspects 10 through 14, wherein the instructions further cause the one or more processors to: compare the change in the ranking of the agent in the ranking of the plurality of agents to a threshold ranking change; and classify the agent as the significant agent based on a comparison of the change in the ranking of the agent to the threshold ranking change.

Aspect 16. The system of Aspects 10 through 15, wherein the instructions further cause the one or more processors to classify the agent as the significant agent based on a position of the agent in being added to the ranking of the plurality of agents.

Aspect 17. The system of Aspects 10 through 16, wherein the instructions further cause the one or more processors to: compare the position of the agent in being added to the ranking of the plurality of agents to a threshold ranking position; and classify the agent as the significant agent based on a comparison of the position of the agent to the threshold ranking position.

Aspect 18. The system of Aspects 10 through 17, wherein the processing of the subset of the raw AV data separate from the raw AV data excluded from the subset of the raw AV data includes processing the subset of the raw AV data while refraining from processing at least a portion of the raw AV data excluded from the subset of the raw AV data.

Aspect 19. A non-transitory computer-readable storage medium having stored therein instructions which, when executed by one or more processors, cause the one or more processors to: access raw autonomous vehicle (AV) data associated with the AV operating in an environment; classify an agent in the environment, during a process of acquiring the raw AV data, as a significant agent based on a potential for the agent to interact with the AV in the environment, wherein the agent is identifiable in the environment through the raw AV data; select a subset of the raw AV data associated with a classification of the agent as the significant agent; and facilitate processing of the subset of the raw AV data separate from the raw AV data excluded from the subset of the raw AV data.

Aspect 20. The non-transitory computer-readable storage medium of Aspect 19, wherein the processing of the subset of the raw AV data separate from the raw AV data excluded from the subset of the raw AV data includes processing the subset of the raw AV data while refraining from processing at least a portion of the raw AV data excluded from the subset of the raw AV data.

Aspect 21. A system comprising means for performing a method according to any of Aspects 1 through 9.

What is claimed is:

1. A method comprising:
accessing raw autonomous vehicle (AV) data associated with the AV operating in an environment;
classifying an agent in the environment, during a process of acquiring the raw AV data, as a significant agent based on a potential for the agent to interact with the AV in the environment, wherein the agent is identifiable in the environment through the raw AV data;
selecting a subset of the raw AV data associated with a classification of the agent as the significant agent; and
facilitating processing of the subset of the raw AV data separate from the raw AV data excluded from the subset of the raw AV data.

2. The method of claim 1, wherein the subset of the raw AV data includes raw AV data before the agent is classified as the significant agent, raw AV data while the agent is classified as the significant agent, raw AV data after the agent is classified as the significant agent, or a combination thereof.

3. The method of claim 1, wherein the agent is classified as the significant agent from a plurality of agents in the environment that are identifiable in the environment through the raw AV data, the method further comprising:
ranking the plurality of agents in the environment to generate a ranking of the plurality of agents based on a corresponding potential for each of the plurality of agents to interact with the AV in the environment; and
classifying the agent as the significant agent based on a ranking of the agent amongst the plurality of agents in the ranking of the plurality of agents.

4. The method of claim 3, wherein the corresponding potential for each of the plurality of agents to interact with the AV in the environment is measured based on a corresponding planning cost associated with controlling the AV in relation to each of the plurality of agents.

5. The method of claim 3, further comprising classifying the agent as the significant agent based on a change in the ranking of the agent amongst the plurality of agents in the ranking of the plurality of agents.

6. The method of claim 5, further comprising:
comparing the change in the ranking of the agent in the ranking of the plurality of agents to a threshold ranking change; and
classifying the agent as the significant agent based on a comparison of the change in the ranking of the agent to the threshold ranking change.

7. The method of claim 3, further comprising classifying the agent as the significant agent based on a position of the agent in being added to the ranking of the plurality of agents.

8. The method of claim 7, further comprising:
comparing the position of the agent in being added to the ranking of the plurality of agents to a threshold ranking position; and
classifying the agent as the significant agent based on a comparison of the position of the agent to the threshold ranking position.

9. The method of claim 1, wherein the processing of the subset of the raw AV data separate from the raw AV data excluded from the subset of the raw AV data includes processing the subset of the raw AV data while refraining from processing at least a portion of the raw AV data excluded from the subset of the raw AV data.

10. A system comprising:
one or more processors; and
at least one computer-readable storage medium having stored therein instructions which, when executed by the one or more processors, cause the one or more processors to:
access raw autonomous vehicle (AV) data associated with the AV operating in an environment;
classify an agent in the environment, during a process of acquiring the raw AV data, as a significant agent based on a potential for the agent to interact with the AV in the environment, wherein the agent is identifiable in the environment through the raw AV data;
select a subset of the raw AV data associated with a classification of the agent as the significant agent; and
facilitate processing of the subset of the raw AV data separate from the raw AV data excluded from the subset of the raw AV data.

11. The system of claim 10, wherein the subset of the raw AV data includes raw AV data before the agent is classified as the significant agent, raw AV data while the agent is classified as the significant agent, raw AV data after the agent is classified as the significant agent, or a combination thereof.

12. The system of claim 10, wherein the agent is classified as the significant agent from a plurality of agents in the environment that are identifiable in the environment through the raw AV data, and the instructions further cause the one or more processors to:
rank the plurality of agents in the environment to generate a ranking of the plurality of agents based on a corresponding potential for each of the plurality of agents to interact with the AV in the environment; and
classify the agent as the significant agent based on a ranking of the agent amongst the plurality of agents in the ranking of the plurality of agents.

13. The system of claim 12, wherein the corresponding potential for each of the plurality of agents to interact with the AV in the environment is measured based on a corresponding planning cost associated with controlling the AV in relation to each of the plurality of agents.

14. The system of claim 12, wherein the instructions further cause the one or more processors to classify the agent as the significant agent based on a change in the ranking of the agent amongst the plurality of agents in the ranking of the plurality of agents.

15. The system of claim 14, wherein the instructions further cause the one or more processors to:
compare the change in the ranking of the agent in the ranking of the plurality of agents to a threshold ranking change; and
classify the agent as the significant agent based on a comparison of the change in the ranking of the agent to the threshold ranking change.

16. The system of claim 12, wherein the instructions further cause the one or more processors to classify the agent as the significant agent based on a position of the agent in being added to the ranking of the plurality of agents.

17. The system of claim 16, wherein the instructions further cause the one or more processors to:
compare the position of the agent in being added to the ranking of the plurality of agents to a threshold ranking position; and
classify the agent as the significant agent based on a comparison of the position of the agent to the threshold ranking position.

18. The system of claim 10, wherein the processing of the subset of the raw AV data separate from the raw AV data excluded from the subset of the raw AV data includes processing the subset of the raw AV data while refraining from processing at least a portion of the raw AV data excluded from the subset of the raw AV data.

19. A non-transitory computer-readable storage medium having stored therein instructions which, when executed by one or more processors, cause the one or more processors to:
access raw autonomous vehicle (AV) data associated with the AV operating in an environment;
classify an agent in the environment, during a process of acquiring the raw AV data, as a significant agent based on a potential for the agent to interact with the AV in the environment, wherein the agent is identifiable in the environment through the raw AV data;
select a subset of the raw AV data associated with a classification of the agent as the significant agent; and
facilitate processing of the subset of the raw AV data separate from the raw AV data excluded from the subset of the raw AV data.

20. The non-transitory computer-readable storage medium of claim 19, wherein the processing of the subset of the raw AV data separate from the raw AV data excluded from the subset of the raw AV data includes processing the subset of the raw AV data while refraining from processing at least a portion of the raw AV data excluded from the subset of the raw AV data.
